(19) United States
(12) Patent Application Publication
(10) Pub. No.: US 2007/0224091 A1
(43) Pub. Date: Sep. 27, 2007

(54) Organic compound synthesizing device, light irradiation device, and substrate for organic compound synthesis

(75) Inventor: Hideaki Okayama, Tokyo (JP)

Correspondence Address: RABIN & Berdo, PC, 1101 14TH STREET, NW, SUITE 500, WASHINGTON, DC, 20005, US

(73) Assignees: OKI ELECTRIC INDUSTRY CO., LTD., Tokyo (JP); OKI DATA CORPORATION, Tokyo (JP); OKI DIGITAL IMAGING CORPORATION, Tokyo (JP)

(21) Appl. No.: 11/654,674

(22) Filed: Jan. 18, 2007

(30) Foreign Application Priority Data
Mar. 22, 2006 (JP) 2006-79035

(51) Int. Cl. B01J 19/00

(52) U.S. Cl. 422/131; 257/98

(57) ABSTRACT

An organic compound synthesizing device, a light irradiation device, and a substrate for synthesizing an organic compound are provided that can handle rapid modification of the sequence pattern of an organic compound, and synthesize an organic compound that is outstanding in terms of uniformity. The organic compound synthesizing device according to the invention uses light irradiation to synthesizes a polymerized organic compound that includes one, two or more types of polymerizable repeating units. The organic compound synthesis substrate holds an organic material used for synthesizing the organic compound, and the light irradiation device irradiates light that is required for synthesis onto the organic compound synthesis substrate. The organic compound synthesizing device includes the organic compound synthesis substrate and at least one of the light irradiation device.

### CROSS REFERENCE TO RELATED APPLICATIONS

The disclosure of Japanese Patent Application No. JP-A-2006-79035 filed on Mar. 22, 2006 including the specification, drawings and abstract is incorporated herein by reference in its entirety.

### BACKGROUND OF THE INVENTION

The invention relates to an organic compound synthesizing device, a light irradiation device, and a substrate for organic compound synthesis.

In diagnosis using deoxyribonucleic acid (DNA) that is living matter, research and practical application is continuing on methods that use a chip having a substrate on which DNA is arrayed (called a DNA chip or a oligonucleotide microarray, and hereinafter referred to as “DNA chip”). Such chips are regarded as essential to achieving “tailor-made medicine” that is able to respond to the differences of each and every individual.

FIG. 9A, FIG. 9B are schematic views that illustrate a DNA chip; and FIG. 10A to FIG. 10F are schematic views that respectively illustrate the manufacturing method of the DNA chip shown in FIG. 9A, FIG. 9B. In addition, FIG. 11A, FIG. 11B are schematic views showing the operation principle of the DNA chip.

FIG. 10A is a plan view of the DNA chip. The DNA chip includes a substrate 10 on which blocks 20 are used to fix segments of DNA. The blocks 20 are formed to in a lengthwise-breadth wise grid arrangement. DNA segments with different sequences are fixed among the respective blocks 20. Two types of method for manufacturing this type of DNA chip are known, namely, a method in which sufficient DNA for the blocks is synthesized in advance and then placed on the respective blocks 20 on the substrate 10, or a method in which nucleic acid is attached to each block 20 and then synthesis performed.

United States Patent Application No. 2005-0079529, U.S. Pat. No. 6,600,031, and U.S. Pat. No. 6,375,903 propose methods like that described above. In these methods, material corresponding to four bases is used to directly synthesize a chosen DNA sequence on a substrate, or optical lithography is used to a form a DNA pattern on a substrate, or DNA patterning is performed using an ink jet technique.

Next, FIG. 9B and FIG. 10A to FIG. 10F will be used to explain an outline of the method described above in which nucleic acid is attached onto the substrate and synthesis performed. First, FIG. 9B is a sectional expanded view of one of the DNA chip blocks 20 of FIG. 9A. The DNA chip includes protecting groups 40 that are linked to the block 20 by linkers 30. Next, DNA having a chosen sequence is synthesized by performing in order the process shown in FIG. 10A to FIG. 10F.

FIG. 10A is a schematic view showing a state in which the linkers 30, in which the protection group 40 has been introduced, are attached to the base 20. As can be seen in FIG. 10B, the protection group 40 reacts to light or acid 50, and detaches from the linkers 30. As a result, a linker end section 30a having a hydrogen atom at the end is formed. Then, when a base 60a in which the protection group 40 has been introduced is reacted, a section having an isopropyl (iPr) base of the base 60a attaches to the linker end section 30a (FIG. 10C). This process is then repeated. More specifically, light or acid 50 is irradiated or supplied to the protection group 40 to which a new base is to be attached. As a result, the protection group 40 detaches (FIG. 10D). Then, when a base 60b to which the protection group 40 has been introduced is reacted with the introduced base 60b, the new base 60b attaches at the position where the protection group 40 used to be (FIG. 10E). This process is repeated until a chosen base sequence 70 is formed (FIG. 10F). The same process can be performed for each of the blocks so as to manufacture a microarray.

When the microarray manufactured in the above-described manner is used in gene diagnosis, as shown in FIG. 11A, FIG. 11B, the base sequence of, for example, RNA synthesized using a gene expressed in a sample or DNA itself is obtained (80a, 80b), and florescent labels 90a, 90b etc. that can obtain the signal necessary for RNA detection are added. When this sample is added to the microarray, only the sequence 70 on the microarray and the complementary RNA or the DNA 80b bond with determined sections of the base sequence. The fluorescence emitted by the fluorescent label 90b bonded with the RNA that remains in the microarray is detected in order identify what kind of gene is expressed in the sample. In this manner, the gene can be used to diagnose the disease.

In this type of microarray, the type of base sequence of RNA, DNA or the like that is manufactured on the blocks on the substrate can be determined by deciding which blocks 20 to irradiate with light. In addition, various methods for forming the sequence pattern on the substrate using light irradiation have been proposed, including a method using glass mask that is used when manufacturing semiconductor integrated circuits, a method using a micro-machined mirror or liquid crystal developed for displays, and a method using an ink jet technique.

The method using glass mask is preferable when mass producing the same sequence pattern, but cannot handle rapid modification of the sequence pattern. Although the methods using a micro-machined mirror or liquid crystal can handle rapid modification of the sequence pattern, these methods use a projection-based optical system, as with the glass mask method. As a result, there is a limit to how much the device can be reduced in size. In addition, the DNA synthesized on each block on the substrate by the method using glass mask has outstanding uniformity, whereas the compound obtained using the other optical methods or the ink jet technique has problems related to uniformity.

In order to address these problems, it is desirable to provide an organic compound synthesizing device, a light irradiation device, a substrate for synthesizing an organic compound, and a synthesizing method for an organic compound that can rapidly handle modifications in a sequence pattern of an organic compound, and that can synthesize an organic compound that is outstanding in terms of uniformity.

### SUMMARY OF THE INVENTION

The present invention has been devised in light of the above described problems and it is an object thereof to provide an innovative and improved organic compound synthesizing device, light irradiation device, organic compound synthesis substrate, and synthesizing method for an organic compound that can rapidly handle modifications in a sequence pattern of an organic compound, and that can synthesize an organic compound that is outstanding in terms of uniformity.

In order to solve the above-described problems, a first aspect of the invention provides an organic compound synthesis device that uses light irradiation to synthesize a polymerized organic compound including at least one type of polymerizable repeating unit. The organic compound synthesizing device includes an organic compound synthesis substrate that holds an organic material for synthesizing the organic compound; and at least one light irradiation device that irradiates the organic compound synthesis substrate -with light required for synthesis.

According to the above structure, the light irradiation device irradiates light, which is required for synthesis of the organic compound, on to the organic compound synthesis substrate which holds the organic material necessary for synthesis of the organic compound. As a result, light irradiation is used to synthesize the polymerized organic compound that includes at least one type of polymerizable repeating unit on the organic compound synthesis substrate.

In order to solve the above-described problems, a second aspect of the invention provides a light irradiation device including an optical element and an optical element holding plate that holds the optical element. The optical element includes a light source, and a phase plate that introduces a phase to a light beam emitted from the optical source and that is connected to the light source. The light irradiation device is used to irradiate light to synthesize a polymerized organic compound including at least one type of polymerizable repeating unit.

According to the above structure, the phase plate provided in the optical element introduces a phase difference to the light beam from the light source, and the optical element holding plate holds the optical element. The light irradiation device having the above structure can make the light distribution of the light emitted from the light source uniform.

The above-described optical element may further include a lens that changes the light beam emitted from the light source to a light beam with a small beam divergence angle. According to this structure, the lens changes the light beam emitted from the light source that passes through the lens into a light beam with a small beam divergence angle. As a result, dissipation of the light emitted from the light source is inhibited.

The above-described light source may be a light-emitting element using a semi-conductor, or may be a light-emitting diode. If this structure is adopted, it is possible to make the magnitude of the light source smaller.

The optical element may further include a condensing lens that focuses the light beam emitted from the light source. This condensing lens can efficiently focus the light beam emitted from the light source.

The optical element may be covered by a housing structure. The housing structure has an opening through which the light beam emitted from the optical element passes, and a light shielding member is provided around the periphery of the opening.

The above-described light irradiation device can introduce a phase of 180 degree to the light beam emitted from the light source. According to this structure, the phase of 180 degree is introduced to the light beam emitted from the light source, thereby forming a section in the light distribution of the light beam emitted from the light source that has even light intensity.

A plurality of the optical element may be provided, and the plurality of optical elements may be positioned in an array arrangement on a single optical element holding plate. According to this structure, the above optical elements can irradiate a plurality of positions with light at one time.

The plurality of optical elements may be controlled individually. This structure makes it possible to select the positions that are irradiated with light.

In order to solve the above problems, a third aspect of the invention provides an organic compound synthesis substrate that is used to synthesize a polymerized organic compound by light irradiation, the organic compound including at least one type of polymerizable repeating unit. The organic compound synthesis substrate includes a substrate; and a light shielding layer that is provided on one side surface of the substrate. The light shielding layer is formed with openings that are formed in a lengthwise-breadthwise grid arrangement. The light shielding layer makes the light irradiated from the light irradiation device have an even light distribution.

According to the above structure, the light shielding layer formed on the substrate shields light irradiated from the light irradiation device such that light having an even light distribution is only irradiated on the openings that are formed in the lengthwise-breadthwise grid arrangement in the light shielding layer. As a result, the organic compound, which is polymerized by light irradiation and which includes at least one type of repeating unit, is synthesized uniformly in the openings.

A spacer layer may be provided on top of the light shielding layer, and the thickness of the spacer layer may be set equal to or less than the wavelength of the irradiated light.

The other surface of the substrate may be provided with recess portions at positions that correspond with the openings. The irradiated light is focused by the recess portions. According to this structure, the recess portions formed in the substrate function as lenses that focus the irradiated light.

In order to solve the above-described problems, a fourth aspect of the present invention provides a method for synthesizing a polymerized organic compound using light irradiation. The organic compound includes at least one type of polymerizable repeating unit. The method includes the steps of (a) supplying an organic material for polymerizing the organic compound to the above-described organic compound synthesis substrate, and (b) using the above-described light irradiation device to irradiate light onto the organic material on the organic compound synthesis substrate

According to the above structure, the organic compound is synthesized on the organic compound synthesis substrate by using the light irradiation device to irradiate light necessary for polymerization onto the organic material supplied onto the organic compound synthesis substrate. As a result, it is possible to manufacture an organic compound array on which organic compound is fixed.

In the above-described step (b), the organic compound synthesis substrate and the light irradiation device may be moved relative to each other. Moving the organic compound synthesis substrate and the light irradiation device relative to each other allows synthesis to be performed more efficiently.

The above-described steps (a) and (b) may be repeatedly performed in order. If this method is adopted, it is possible to manufacture an organic compound array including synthesized organic compound formed from a chosen number of repeating units.

The present invention provides an organic compound synthesizing device, a light irradiation device, a substrate for synthesizing an organic compound, and a synthesizing method for an organic compound that can rapidly handle modifications in a sequence pattern of an organic compound, and that can synthesize an organic compound that is outstanding in terms of uniformity.

### BRIEF DESCRIPTION OF THE DRAWINGS

FIG. 1A is a schematic view that illustrates an outline of a light irradiation device and a substrate for synthesizing an organic compound according to a first embodiment of the present embodiment;

FIG. 1B is a schematic view that illustrates an outline of the substrate for synthesizing an organic compound according to the first embodiment of the present invention;

FIG. 2 is a plan view of the light irradiation device according to the first embodiment of the present invention;

FIG. 3 is a schematic view that illustrates an outline of the function of the light irradiation device according to the first embodiment of the present invention;

FIG. 4 is a perspective view of the light irradiation device and the substrate for synthesizing an organic compound according to the first embodiment of the present invention;

FIG. 5 is a perspective view of the light irradiation device and the substrate for synthesizing an organic compound according to the first embodiment of the present invention;

FIG. 6A is a schematic view that illustrates an outline of an substrate for synthesizing an organic compound according to a second embodiment of the present invention;

FIG. 6B is a schematic view that illustrates an outline of a light irradiation device and the substrate for synthesizing an organic compound according to the second embodiment of the present invention;

FIG. 7 is a schematic view that illustrates an outline of a light irradiation device and a substrate for synthesizing an organic compound according to a third embodiment of the invention;

FIG. 8A is a graph that shows simulated results for the light irradiation device according to the first embodiment of the present invention;

FIG. 8B is a graph that shows simulated results for the light irradiation device according to the first embodiment of the present invention;

FIG. 8C is a graph that shows simulated results for the light irradiation device according to the first embodiment of the present invention;

FIG. 9A is a schematic view that illustrates an outline of a known DNA chip;

FIG. 9B is a schematic view that illustrates the outline of the known DNA chip;

FIG. 10A is a schematic view that illustrates an outline of a manufacturing method of the known DNA chip;

FIG. 10B is a schematic view that illustrates the outline of the manufacturing method of the known DNA chip;

FIG. 10C is a schematic view that illustrates the outline of the manufacturing method of the known DNA chip;

FIG. 10D is a schematic view that illustrates the outline of the manufacturing method of the known DNA chip;

FIG. 10E is a schematic view that illustrates the outline of the manufacturing method of the known DNA chip;

FIG. 10F is a schematic view that illustrates the outline of the manufacturing method of the known DNA chip;

FIG. 11A is a schematic view that shows an outline of the known DNA chip in a functioning state; and

FIG. 11B is a schematic view that shows an outline of the known DNA chip in the functioning state.

### DETAILED DESCRIPTION OF THE PREFERRED EMBODIMENTS

Hereinafter, preferred embodiments of the present invention will be described in detail with reference to the appended drawings. Note that, in this specification and the drawings, structural elements that have substantially the same function and structure are denoted with the same reference numerals, and repeated explanation of these structural elements is omitted.

### First Embodiment

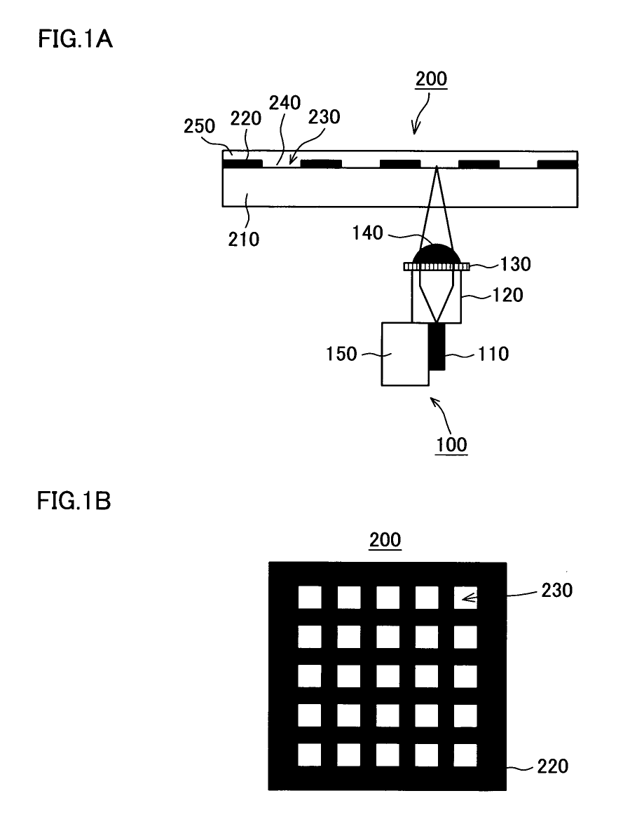

FIG. 1A is a schematic view that illustrates an outline of a light irradiation device 100 and a substrate for synthesizing an organic compound 200 (hereinafter called “organic compound synthesis substrate 200”) according to a first embodiment of the present embodiment; and FIG. 1B is a schematic view that illustrates an outline of the organic compound synthesis substrate 200.

FIG. 1A is a side view of the light irradiation device 100 and the organic compound synthesis substrate 200 according to the present embodiment, and FIG. 1B is a plan view of the organic compound synthesis substrate 200 according to the present embodiment.

The light irradiation device 100 according to the present embodiment includes an optical element formed from a light source 110, a collimate lens 120, a phase plate 130, and a condensing lens 140, and an optical element holding plate 150 that holds the optical element.

The light source 110 emits a light having a determined wavelength. The light source 110 may use, for example, an optical element using a semiconductor. Examples of such optical elements using a semiconductor include a semiconductor laser or a light-emitting diode. With regard to selection of the emitted light wavelength, an emitted light wavelength may be selected that corresponds with the light energy required for synthesizing the organic compound. However, it is favorable to use a light source that emits light having a short wavelength since this allow greater light energy to be obtained. Given this consideration, a light emitting diode that emits blue light with a wavelength of around 400 nm is used in this embodiment.

The collimate lens 120 functions to change light incident on the lens 120 to a light beam with a small beam divergence angle, for example, collimated light. However, it is possible to use any type of lens so long as it can form collimated light. From the point of view of cost, however, it is favorable to use a rod lens like that normally used in a light emitting diode printer.

The phase plate 130 functions to introduce a phase difference to the light that passes through the collimate lens 120. The phase difference introduced by the phase plate 130 can be set as chosen. The phase plate 130 introduces the set phase difference to the light incident on the phase plate 130, thereby forming a light distribution of the incident light.

The condensing lens 140 functions to focus the light that passes through the phase plate 130 at the position of the focal point of the condensing lens 140. The condensing lens 140 may be selected from a spherical lens, an aspherical lens, or the like.

The above-described light source 110, the collimate lens 120, the phase plate 130, and the condensing lens 140 form the optical element. The optical element is supported by the optical element holding plate 150.

The optical element holding plate 150, as can be seen in FIG. 1A, supports one surface of the light source 110 and a section of an end surface of the collimate lens 120. However, the optical element holding plate 150 may be provided such that it surrounds the periphery of the light source 110. The light irradiation device 100 according to the present embodiment is structured as described above.

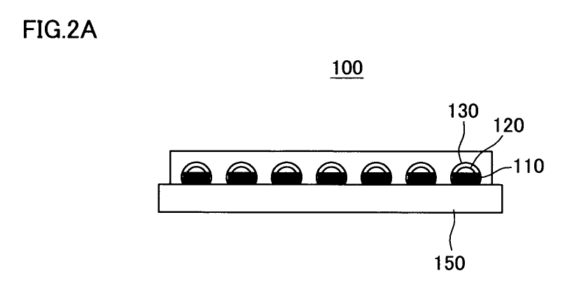

FIG. 2 is a plan view of the light irradiation device 100 according to the present embodiment when viewed from the direction of the optical axis. The light irradiation device 100 according to the present embodiment, as can be seen in FIG. 2, is provided with a plurality of optical elements that are held by a single one of the optical element holding plate 150. However, an array arrangement may be adopted. In this case, the phase plate 130 may be formed as a single large plate, and the collimate lenses 120 and the condensing lenses 140 connected thereto. In addition, the light source 110 may be connected to the collimate lenses 120.

If the light source 110 is formed in an array arrangement, it is possible to irradiate light onto a plurality of points of the organic compound synthesis substrate 200 at one time. Furthermore, if each of the plurality of light sources 1 10 is controlled independently it is possible to choose which points are irradiated with light.

As can be seen in FIG. 1A and FIG. 2, in each optical element, the light source 110, the collimate lens 120, the phase plate 130, and the condensing lens 140 are provided on the same light axis.

The organic compound synthesis substrate 200 according to the first embodiment of the present invention includes, as shown in FIG. 1A, a substrate 210, a light shielding layer 220, openings 240 and a spacer layer 250.

The substrate 210 may be any normally used substrate such as a glass or a plastic substrate. As shown in FIG. 1B, the light shielding layer 220 is formed by light shielding members that are provided on one of the surfaces of the substrate 210. A plurality of openings 240 are provided in a breadthwise-lengthwise grid arrangement in the light shielding layer 220. The openings 240 are the regions of the light shielding layer 220 that are not covered by the light shielding members, and are recessed portions formed in the light shielding layer 220. The openings 240 function as blocks 230 in the organic compound synthesis substrate 200 according to the present embodiment.

The light shielding layer 220 may be formed using a material that can shield light like, for example, metal, a coating material, or carbon. The light shielding material that is adopted needs to be changed in accordance with the emitted light wavelength of the light source 110.

The plurality of openings 240 formed in the breadthwise-lengthwise array arrangement in the light shielding layer 220 are portions to which the organic compound synthesized by the irradiated light from the light irradiation device 100 are fixed.

In addition, the light shielding layer 220 and the openings 240 formed in the light shielding layer 220 functions as slits for the light emitted from the light irradiation device 100. Accordingly, the width of the openings 240 formed in the light shielding layer 220 can be modified in order to make the light distribution of the irradiated light from the light irradiation device 100 uniform.

The space layer 250, which uses the same material as the substrate 210, may be provided on top of the light shielding layer 220. In the case that the spacer layer 250 is provided, it is favorable to make the thickness of the spacer layer 250 roughly correspond with the emitted light wavelength of the light source 110.

In the case that the spacer layer 250 is provided, as shown in FIG. 1A, the spacer layer 250 may be structured such that the openings 240 are filled by the material that forms the spacer layer 250, with the surface of the spacer layer 250 having a generally flat surface. Alternatively, the spacer layer 250 may not be provided in the portions of the openings 240, and the blocks 230 may be maintained as recessed portions. In addition, the spacer layer 250 may be formed such that the portions that correspond to the openings 240 have a protruding shape.

In the case that the portions corresponding to the openings 240 formed by the spacer layer 250 are given a substantially flat surface or a protruding shape, if the reagent necessary for synthesizing the organic compound is a liquid, surface processing of the spacer layer 250 may be carried out to control the affinity of the surface and the liquid. As a result, the liquid may be held on the surface using surface tension of the liquid itself.

In the case that the spacer layer 250 is provided, the portions of the spacer layer 250 located above the openings 240 function as the blocks 230 of the organic compound synthesis substrate 200 according to the present embodiment.

The light irradiation device 100 according to the present embodiment, as shown in FIG. 1A, may irradiate light toward the substrate 200 from the rear side surface (the surface on the z-axis negative direction side) of the organic compound synthesis substrate 200. This is because, in the case that a supply device for supplying organic material for synthesizing the organic compound is provided, for example, on the organic compound synthesis substrate 200, there is a possibility that the optical axis of the light irradiation device 100 and the organic material supply device could overlap. Moreover, if a light emitting diode is used for the light source 110 of the light irradiation device 100, the focal length of the light-emitting diode is often short. As a result, it is necessary to make the distance between the openings 240 and the light-emitting diode short. In this case, it is preferable if light is irradiated from the rear surface of the organic compound synthesis substrate 200.

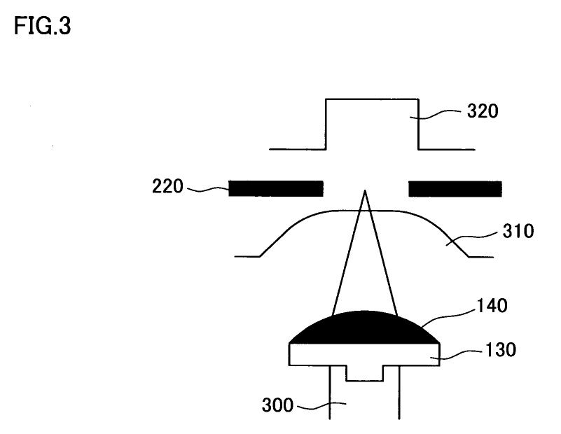

Next, FIG. 3 will be used to explain the function of the light irradiation device 100 and the light shielding layer 220 in the organic compound synthesis substrate 200 according to the present embodiment. FIG. 3 is a schematic view that illustrates the function of the light irradiation device 100 and the light shielding layer 220 in the organic compound synthesis substrate 200 according to the present embodiment.

As can be seen in FIG. 3, light emitted from the light source 110 is formed into a collimated light beam 300 by the collimate lens 120. The phase plate 130 introduces a determined phase to the light beam 300. The phase plate 130, as shown in FIG. 3, has, for example, a generally protruding shape. The range of the phase difference introduced to the light beam 300 is determined by the width of the protruding portion that protrudes in the direction orthogonal to the optical axis. The introduced phase difference is determined by the height of the protruding portion in the direction parallel to the optical axis.

When a phase difference is introduced to a section of the light beam 300, the light distribution of the section with the phase difference changes. For example, in the case that the light beam 300 is a Gaussian beam, when the phase difference is introduced by the phase plate 130 to the Gaussian beam, a light beam 310 that has passed through the phase plate 130 is a light beam with an even section as shown in FIG. 3. Use of this configuration allows an even section to be formed in the light distribution. This even section has uniform light energy.

The light beam having the even light distribution formed by the phase plate 130 is focused at the position of the focal point of the condensing lens 140. Note that, it is favorable that the gap between the condensing lens 140 and the light shielding layer 220 is set to be the same as the focal length of the condensing lens 140. If this configuration is adopted, the light beam 300 focused on each opening 240 has that highest possible light intensity.

When the light beam 310, which has the light distribution formed with the even section, is focused on the light shielding layer 220, the light shielding layer 220 itself functions as a slit, thereby further cutting out unnecessary light. Accordingly, a light beam 320 is formed that has an even light distribution. The light beam 320 with the even light distribution is a light beam that has even light intensity. Because this light beam having an even light intensity is irradiated across the entire width of any single one of the openings 240 formed in the organic compound synthesis substrate 200, there is no unevenness in the reaction that occurs in the organic material that is locally applied above the opening 240. As a result, the organic compound synthesized in each single block 230 is uniform.

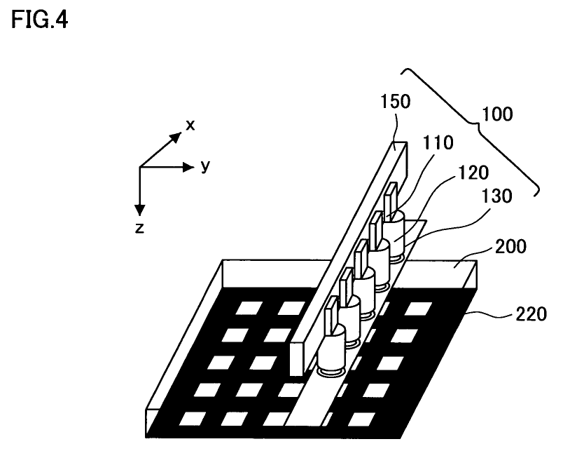

FIG. 4 is a perspective view of the light irradiation device 100 and the organic compound synthesis substrate 200 according to the present embodiment. As is clearly apparent from FIG. 4, the number of optical elements provided in the light irradiation device 100 according to the present embodiment is the same as the number of the blocks 230 formed along the x-axis direction in the organic compound synthesis substrate 200. In addition, each optical element that forms the light irradiation device 100 can be controlled separately.

As described above, the number of the optical elements and the number of the blocks 230 formed in the direction parallel to the light irradiation device 100 correspond with each other one-to-one. As a result, controlling the light sources 110 of the optical elements to be switched on and off allows the corresponding blocks 230 to be exposed/not exposed to light. In this manner, the light irradiation device 100 and the organic compound synthesis substrate 200 according to the present embodiment can be used to allow rapid handling of modification of the sequence pattern of the organic compound.

The light irradiation device 100 may, for example, scan the organic compound synthesis substrate 200 in the y-axis direction, and then expose a row of the blocks 230 in the direction parallel (the x-axis) to the light irradiation device 100 to light. For example, if a total of Nₛ blocks 230 exist that need to be exposed, and the time needed to expose each one of the blocks 230 is t, then the total exposure time will be Nₛ×t for the entire organic compound synthesis substrate 200.

In addition, if a light-emitting diode is used as the light source 110 of the light irradiation device 100, it is possible to increase the amount of light as compared to known methods employing a mercury lamp. As a result, the time required for the photochemical reaction that synthesizes the organic compound is reduced.

When the organic compound is synthesized, and in particular when the base is repeatedly reacted 25 to 70 times in DNA synthesis or the like, position alignment is necessary for each light exposure. With the organic compound synthesis substrate 200 according to the present embodiment, this position alignment can be performed by detecting the pattern of the light shielding layer 220. In the organic compound synthesis substrate 200 according to the present embodiment, since the light shielding members that function as the light shielding layer 220 are formed on the substrate 210, the requirement for positional accuracy is not that stringent, and, for example, accuracy of a few μm is adequate.

Note that, in the illustration of FIG. 4 there is a one-to-one relationship of the light sources 110 and collimate lenses 120. However, the design may include a plurality of light sources 110 that share one of the collimate lens 120, the phase plate 130, and the condensing lens 140. If this structure is adopted, the gap (pitch) between neighboring light sources 110 can be narrowed.

For example, the light emitted by a plurality of light sources 110 may be focused by a single one of the collimate lens 120 etc. or a single one of the condensing lens 140. Furthermore, in FIG. 4, each light source 110 and collimate lens 120 are positioned such that the light axis thereof are aligned. However, a plurality of collimate lenses 120 may be positioned in a zigzag arrangement, and may function together as a single collimate lens.

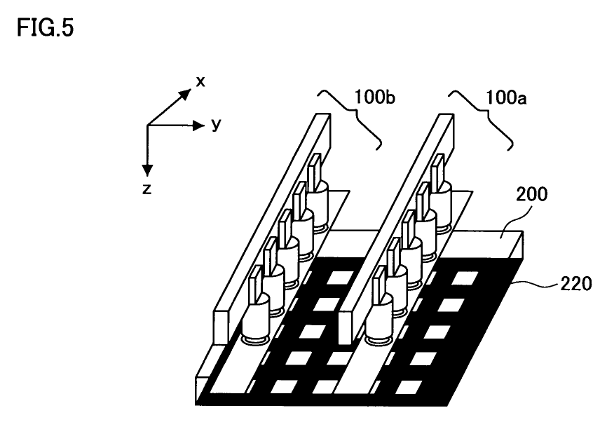

FIG. 4 only shows one of the light irradiation device 100. However, as shown in FIG. 5, a plurality of the light irradiation device 100 may be used. FIG. 5 shows an example in which two light irradiation devices that are the same, namely, a light irradiation device 100a and a light irradiation device 100b, are used to expose each block 230 to light.

If Nₕ units of the light irradiation device 100 are used and light exposure is carried out simultaneously, the time necessary for exposing the organic compound synthesis substrate 200 to light will be 1/Nₕ of the time necessary when a single one of the light irradiation device 100 is used. For example, if the total number of the blocks 230 of the organic compound synthesis substrate 200 is Nₛ, the number of light exposures will be Nₛ/Nₕ. Accordingly, the time necessary to expose all of the organic compound synthesis substrate 200 to light will be (Nₛ/Nₕ)×t. Since the region that is irradiated by each light irradiation device 100 is determined, the relative positions of the light irradiation devices 100 in the Y-axis direction do not need to be that accurate. Accordingly, the accuracy obtainable by performing fine tuning when the light irradiation devices are installed is sufficient.

Note that, FIG. 5 shows an example in which two of the light irradiation device 100 are used. However, the number of light irradiation devices 100 that are installed is not limited to this number, and three or more may be used. In addition, the number of light irradiation devices 100 that are used may be determined in accordance with the size or the like of the organic compound synthesis substrate 200 that needs to be exposed to light.

Next, a description will be given of a method of manufacturing an organic compound array by synthesizing organic compound that is polymerized by irradiation with light using the light irradiation device 100 and the organic compound synthesis substrate 200 described above. The organic compound includes one, two or more types of repeating units that can be polymerized.

Next, synthesis of DNA having a chosen base sequence will be described as an example of the above-mentioned organic compound. In this example, the one, two or more types of polymerizable repeating units are four types of base, namely adenine (A), thymine (T) guanine (G) and cytosine (C).

First, linkers are prepared for fixing the organic compound to the blocks 230 of the organic compound synthesis substrate 200. A protection group, which can be dissociated by irradiation, is attached to the end of each linker.

Next, light is irradiated on the blocks 230 where the base is to be bonded. Accordingly, either one of the light irradiation device 100 or the organic compound synthesis substrate 200 is moved, and then light irradiated. As a result, in the blocks 230 that are irradiated with light, the protection group introduced to the ends of the linkers detaches so that the linkers are capable of bonding to the base.

Following this, a solution, which includes the base that is to be reacted, is supplied to the blocks 230. As a result, the linkers and the base react to generate a base chain.

Next, in the case a second type of base is to be bonded, the above process is repeated in order to form an organic compound synthesis substrate that has DNA having a chosen base sequence fixed thereto. Accordingly, a DNA array is manufactured.

In addition, an organic compound synthesis device including the light irradiation device 100 and the organic compound synthesis substrate 200 according to the present embodiment can be manufactured in order to automate the above described process. This organic compound synthesis device may be provided with, for example, an organic compound supply device that supplies an organic material needed for synthesizing an organic compound.

### Second Embodiment

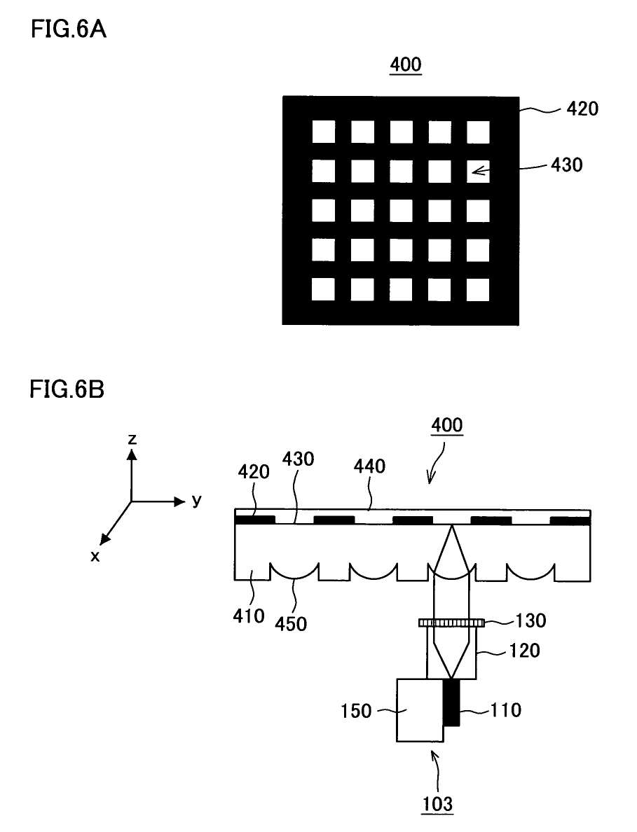

FIG. 6A is a schematic view that illustrates an outline of an organic compound synthesis substrate 400 according to a second embodiment of the present invention; and FIG. 6B is a schematic view that illustrates an outline of a light irradiation device 103 and the organic compound synthesis substrate 400 according to the second embodiment of the present invention.

The light irradiation device 103 according to the present embodiment includes an optical element formed from the light source 110, the collimate lens 120, and the phase plate 130, and the optical element holding plate 150 that holds the optical element. The light irradiation device 103 of the present embodiment differs from the light irradiation device 100 according to the first embodiment of the present invention in that the condensing lens 140 is not provided. However, all other structural features of the light irradiation device 103 are the same as those of the light irradiation device 100 according to the first embodiment of the present invention.

Since the light irradiation device 103 according to the present embodiment does not include the condensing lens 140, light from the light source 110 that passes through the phase plate 130 is irradiated onto the organic compound synthesis substrate 400 according to the present embodiment as unchanged collimated light. Note that, in the case of this embodiment, it is favorable that one of the collimate lens 120 is provided for every one of the light source 110.

The organic compound synthesis substrate 400 according to the present embodiment includes a substrate 410, a light shielding layer 420, and a spacer layer 440.

The substrate 410 may be any normally used substrate such as a glass or a plastic substrate. As shown in FIG. 6A, the light shielding layer 420 is formed by light shielding members that are provided on one of the surfaces of the substrate 410. The light shielding layer 420 and openings 430 provided in the light shielding layer 420 are the same as those in the first embodiment of the present invention and thus a detailed description of these members will be omitted here.

Condensing lens sections 450 that are recessed portions having a lens shape are formed in the surface of the substrate 410 that is on the opposite side to the surface on which the light shielding layer 420 is formed. The optical axes of the condensing lens sections 450, namely, respective center axis that extend parallel to the z-axis of the generally circular shaped portion, are aligned with the center axis of the openings 430 formed in the light shielding layer 420.

In order to effectively focus light in the openings 430, it is favorable that the length of the focal length of the lenses formed in the condensing lens sections 450 is set to match the thickness of the substrate 410. If the length of the focal length of the lenses and the thickness of the substrate 410 do not match each other, part of the light irradiated from each light irradiation device 103 will not be focused in the opening 430.

The above-described condensing lens sections 450 can be formed in the substrate 410 using, for example, a hot press method. In addition, since the relative positional relationship of the openings 430 and the condensing lens sections 450 is important, the openings 430 may be formed using photo lithography.

Note that, because the light irradiated from the light irradiation device 103 according to the present embodiment is collimated light, it is not necessary to adjust the distance between the light irradiation device 103 and the organic compound synthesis substrate 400.

### Third Embodiment

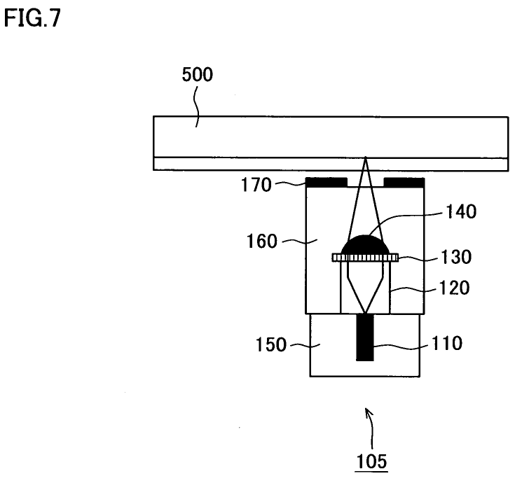

FIG. 7 is a schematic view that illustrates an outline of a light irradiation device 105 and an organic compound synthesis substrate 500 according to a third embodiment of the invention.

The light irradiation device 105 according to the present embodiment includes the optical element formed from the light source 110, the collimate lens 120, the phase plate 130, and the condensing lens 140; the optical element holding plate 150 that holds the optical element; a housing structure 160 that covers the optical element; and a light shielding member 170.

The optical element and the optical element holding plate 150 function in substantially the same manner as those described in the first embodiment, and have the same effects. Accordingly, a detailed explanation of these members will be omitted here. The light irradiation device 105 according to the present embodiment is provided with the housing structure 160 that covers the optical element in order to attach the light shielding member 170. The housing structure 160 is provided such that it surrounds the periphery of the optical element, and is connected to the optical element holding plate 150. An opening is provided in the housing structure 160 at a position on the optical axis of the optical element. The light shielding member 170 is positioned around the opening. The material that is used for the light shielding member 170 is a material that shields light such as a metal, a coating material or carbon.

The light emitted from the light source 110 passes through the phase plate 130 and becomes light having an even section like that shown in FIG. 3. The light having the even section passes through the slit formed by the light shielding member 170 provided in the housing structure 160. Accordingly, light having even light intensity is irradiated from the light irradiation device 105 onto the organic compound synthesis substrate 500.

Because the light shielding member 170 is attached to the light irradiation device 105 according to the present embodiment, there is no need to provide a light shielding layer in the organic compound synthesis substrate 500. Thus, the organic compound synthesis substrate 500 can be manufactured more cheaply.

Note that, in the case that the material of the light shielding member 170 provided in the light irradiation device 105 and the organic compound synthesis substrate 500 is a conductor like metal or the like, the space between the light irradiation device 105 and the organic compound synthesis substrate 500 will act like a condenser. If this structure is adopted, the capacitance of the condenser formed by the light irradiation device 105 and the organic compound synthesis substrate 500 can be monitored in order to determine the distance between the light irradiation device 105 and the organic compound synthesis substrate 500. Furthermore, if the minute current passing through the condenser is used to drive a Piezo element, the position of the light irradiation device 105 can be adjusted with sub-micron distance accuracy.

Next, the light irradiation device 100 and the organic compound synthesis substrate 200 according to the first embodiment of the present invention will be explained while describing a specific example.

Simulation Method

In order to simulate the light irradiation device 100 according to the first embodiment of the present invention the following conditions were set.

The emitted light wavelength of the light emitted from the light source 110 is 420 nm blue light, and is a Gaussian beam having a 40 μm light beam diameter. The phase plate 130 has a concentric circle shape that has an area that is around 70% of the light beam, namely, around 30 μm. The phase plate 130 introduces a 180° phase difference. The distance between the condensing lens 140 and light shielding layer 220 of the organic compound synthesis substrate 200 is 1 mm (1000 μm). Further, the distance between the light source 110 and the phase plate 130 is 120 μm.

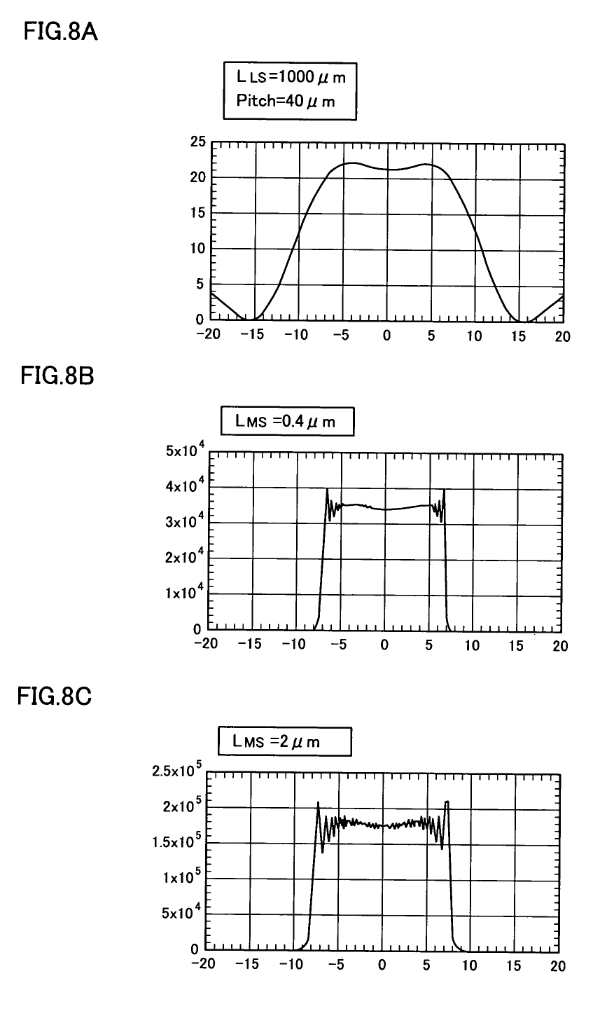

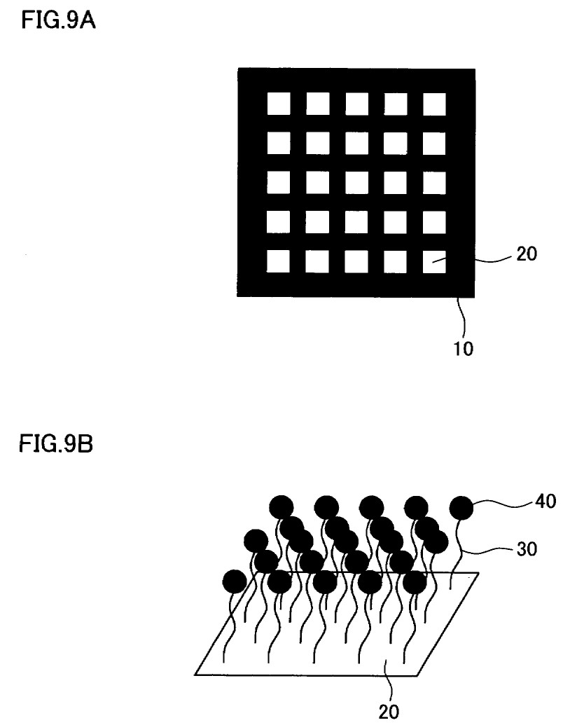

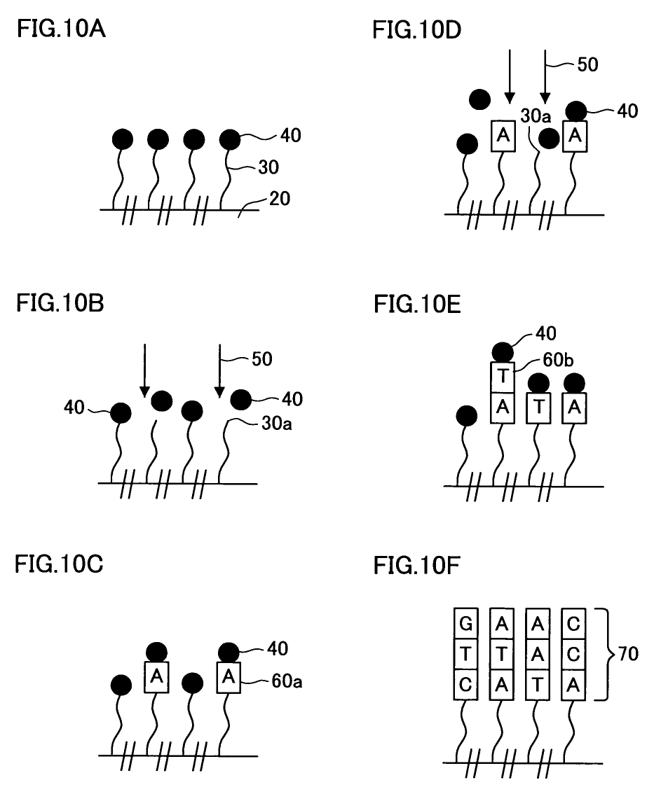

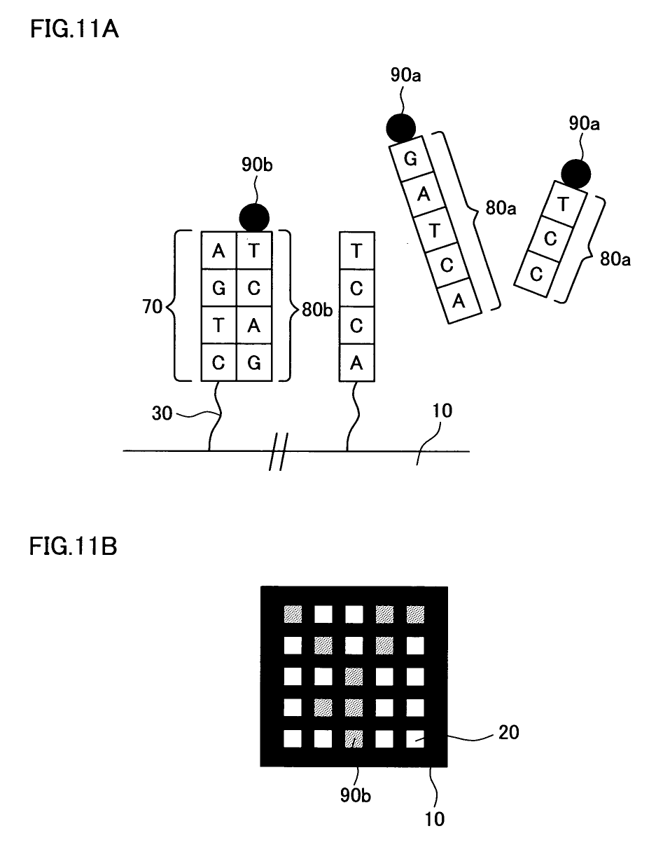

FIG. 8A to 8C are graphs that show simulated results for the light irradiation device 100 according to the first embodiment of the present invention. The horizontal axis of each graph shows the diameter of the Gaussian beam, with the O position indicating the position of the optical axis. Note that, the units of the horizontal axis are μm. The vertical axis of each graph shows the amount of light of the Gaussian beam.

FIG. 8A shows simulated results for the distribution of the light focused on the light shielding layer 220. As can be seen from the graph, within a diameter of around 10 μm, namely, in a range of 5 μm from the optical axis, there is section in which the amount of light is constant. However, in the range of 5 to 15 μm from the optical axis, the amount of light reduces in a sloping manner. Accordingly, there is a section in which the amount of light is not constant around the section in which the amount of light is constant.

FIG. 8B show the light distribution of the light of FIG. 8A after the light has passed through the opening 230. The thickness of the spacer layer 250 is substantially the same as the emitted light wavelength, namely, 0.4 μm (400 nm). Note that, the opening of the opening 230 has a diameter of 14 μm. As can be seen, the amount of the light that passes through the opening 230 suddenly becomes smaller in a section exceeding a radius of 7 μm from the optical axis, and only the section in which the light amount is constant passes through the opening 230. Moreover, as can be seen, there is slight disturbance in the distribution in the section that is around 7 μm radius from the optical axis. This is caused by light that sneaks in at the back side of the light shielding layer 220 as a result of diffraction.

FIG. 8C shows simulation results for an example in which the spacer layer has thickness of 2 μm, and the opening of the opening 230 has a diameter of 14 μm. As can be seen, the distribution is substantially disturbed by light sneaking in at the back side of the light shielding layer 220 because of diffraction from the opening 230. Accordingly, it is clear that disturbance of the amount of light has occurred even in the section in which the amount of light is constant.

From the above-described results, it is clearly apparent that it is favorable to set the thickness of the spacer layer to be roughly equivalent to the emitted light wavelength of the light used for the light source.

As described above, the light irradiation device and the organic compound synthesis substrate according to each embodiment of the present invention can be used to generate an even distribution of irradiated light on the blocks formed in the organic compound synthesis substrate. As a result of irradiating a constant amount of light over the entirety of each block, the organic compound can be synthesized uniformly. Accordingly, it is possible to manufacture an organic compound array having uniform quality.

Hereinabove, preferred embodiments of the present invention have been described with reference to the appended drawings. However, the present invention is not limited to these embodiments. As will be obvious to a person skilled in the art, the invention permits of various modifications and changes without departing from the scope of the claims. Such modifications and changes are understood to come within the scope of the present invention.

For example, in the above embodiments, structures were described in which the phase plate 130 is disposed in the light irradiation device 100. However, instead of the phase plate 130, a ground glass diffuser may be used. In the case that a diffuser is used, an even light distribution is obtained as a result of defocusing.

In addition, in the above-described embodiments, structures were described in which the light from the light source 110 that passes through the collimate lens 120 is incident on the phase plate 130. However, the positions of the phase plate 130 and the collimate lens 120 may be switched such that the light from the light source 110 passes through the phase plate 130 and is incident on the collimate lens 120.

What is claimed is:

1. An organic compound synthesis device that uses light irradiation to synthesize a polymerized organic compound including at least one type of polymerizable repeating unit, comprising:
an organic compound synthesis substrate that holds an organic material for synthesizing the organic compound; and
at least one light irradiation device that irradiates the organic compound synthesis substrate with light required for synthesis.

2. A light irradiation device comprising:
an optical element comprising a light source, and a phase plate that introduces a phase to a light beam emitted from the optical source and that is connected to the light source; and
an optical element holding plate that holds the optical element, wherein
the light irradiation device is used to irradiate light to synthesize a polymerized organic compound including at least one type of polymerizable repeating unit.

3. The light irradiation device according to claim 2, wherein
the optical element further comprises a lens that changes the light beam emitted from the light source to a light beam with a small beam divergence angle.

4. The light irradiation device according to claim 2, wherein
the light source is an light-emitting element using a semi-conductor.

5. The light irradiation device according to claim 4, wherein
the light source is a light-emitting diode.

6. The light irradiation device according to claim 2, wherein
the optical element further comprises a condensing lens that focuses the light beam emitted from the light source.

7. The light irradiation device according to claim 2, wherein
the optical element is covered by a housing structure,
the housing structure has an opening through which the light beam emitted from the optical element passes, and
a light shielding member is provided around the periphery of the opening.

8. The light irradiation device according to claim 2, wherein
the phase plate introduces a phase of 180 degrees to the light beam emitted from the light source.

9. The light irradiation device according to claim 2, wherein
the optical element is provided in a plurality, the plurality of optical elements being positioned in an array arrangement on a single one of the optical element holding plate.

10. An organic compound synthesis substrate that is used to synthesize a polymerized organic compound by light irradiation, the organic compound including at least one type of polymerizable repeating unit, comprising:
a substrate;
a light shielding layer that is provided on one side surface of the substrate, the light shielding layer being formed with openings that are formed in a lengthwise-breadthwise grid arrangement, wherein
the light shielding layer makes light irradiated from a light irradiation device have an even light distribution, the light irradiation device being used to irradiate light to synthesize the polymerized organic compound including the at least one type of polymerizable repeating unit, and comprising an optical element including a light source, and a phase plate that introduces a phase to a light beam emitted from the light source and that is connected to the light source; and an optical element holding plate that holds the optical element.

11. The organic compound synthesis substrate according to claim 10, further comprising:
a spacer layer provided on top of the light shielding layer, wherein
the thickness of the spacer layer is equal to or less than the wavelength of the irradiated light.

12. The organic compound synthesis substrate according to claim 10, wherein
the other surface of the substrate is provided with recess portions at positions that correspond with the openings, and the irradiated light is focused by the recess portions.
